(19) United States
(12) Patent Application Publication
(10) Pub. No.: US 2007/0236386 A1
(43) Pub. Date: Oct. 11, 2007

(54) Device and Method for Exchanging Information Over Terrestrial and Satellite Links

(76) Inventors: Ofer Harpak, Kiryat Tivon (IL); Daniel Bronholc, Ramat A'Sharon (IL); Avi Barda, Hod Hasharon (IL)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/381,283

(22) Filed: May 2, 2006

Related U.S. Application Data
(60) Provisional application No. 60/680,208, filed on May 12, 2005.
(60) Provisional application No. 60/681,577, filed on May 16, 2005.

(51) Int. Cl. H04B 7/185

(52) U.S. Cl. 342/352

(57) ABSTRACT

A system includes a satellite antenna adapted to receive right hand circularly polarized radiation and left hand circularly polarized radiation over a satellite link, and a terrestrial multiple sector antenna adapted to receive terrestrial communication; wherein the satellite antenna is oriented in relation to an imaginary vertical axis that is substantially parallel to multiple elements of the terrestrial multiple sector antenna. A method includes determining an operational mode of a system that comprises a satellite antenna adapted to receive right hand circularly polarized radiation and left hand circularly polarized radiation over a satellite link, and a terrestrial multiple sector antenna adapted to receive terrestrial communication; and selecting, in response to the operational mode, which radiation to output out of the radiation received by at least one receiving element out of the satellite antenna and an antenna element of the terrestrial multiple sector antenna.

### RELATED APPLICATIONS

This application is a NONPROVISIONAL and claims the priority benefit of U.S. provisional patent application No. 60/680,208 filed 12 May 2005, incorporated herein by reference; and further claims the priority benefit of and incorporates by reference U.S. provisional patent application No. 60/681,577, filed 16 May 2005.

### FIELD OF THE INVENTION

The present invention relates to methods and systems employing both satellite and terrestrial antenna adapted to receive various communications.

### BACKGROUND OF THE INVENTION

WiMAX (World Interoperability for Microwave Access) is the name associated with a group of 802.16 IEEE standards as well as related standards such as 802.18, 802.20 AND 802.22. WiMAX allows broadband communication using terrestrial wireless links that uses licensed or unlicensed frequencies.

Part 16 of the 802.16 IEEE standard defines an air interface for fixed broadband wireless access systems. It defines complex MAC and PHY layers that allow a WiMAX transmitter to perform many modulations and to perform multiple carrier transmissions. The MAC layer can dynamically grant access to a shared wireless medium. The MAC layer chip is usually connected to an RF chip that in turn is connected to a microwave antenna.

WiMAX technology is adapted to use terrestrial links for wirelessly conveying information between base stations and mobile or stationary subscriber devices. In some countries the use of WiMax technology is limited and even prevented due to the absence of available spectrum. Thus, there is a need to expand the deployment of WiMAX technology.

### SUMMARY OF THE INVENTION

In one embodiment of the present invention, a system includes a satellite antenna adapted to receive right hand circularly polarized radiation and left hand circularly polarized radiation over a satellite link, and a terrestrial multiple sector antenna adapted to receive terrestrial communication (e.g., WiMax compliant transmissions); wherein the satellite antenna is oriented in relation to an imaginary vertical axis that is substantially parallel to multiple elements of the terrestrial multiple sector antenna. The satellite antenna and the terrestrial multiple sector antenna may be substantially fixed to a structural element. For example, the antennas may be coupled to a structural element and located within a radome; with the structural element pivotally coupled to a base element. Location information may be printed on an external surface of the radome.

In some cases, the system may further include a interfacing unit adapted to selectively output radiation received by at least one receiving element of the satellite antenna and an antenna element of the terrestrial multiple sector antenna. Likewise, embodiments of the present system may include a first reception path for receiving information conveyed over the right hand circularly polarized radiation and a second reception path for receiving different information conveyed over the left hand circularly polarized radiation.

A further embodiment of the present invention provides a method that includes: installing a base element; and rotating an antenna unit that comprises a radome, a satellite antenna adapted to receive right hand circularly polarized radiation and left hand circularly polarized radiation over a satellite link, and a terrestrial multiple sector antenna adapted to receive terrestrial communication; wherein the radome comprises location information such as to direct a radome portion on which location information that corresponds to a location of the system is directed towards a certain direction. The method may further include determining the certain direction by using a low cost direction finding unit, for example a compass, and/or selectively receiving information over the satellite link or over the terrestrial link.

A further method according to an embodiment of the present invention includes: determining an operational mode of a system that includes a satellite antenna adapted to receive right hand circularly polarized radiation and left hand circularly polarized radiation over a satellite link, and a terrestrial multiple sector antenna adapted to receive terrestrial communication; and selecting, in response to the operational mode, which radiation to output out of the radiation received by at least one receiving element out of the satellite antenna and an antenna element of the terrestrial multiple sector antenna. A first operational mode of such a system may include receiving information conveyed over the right hand circularly polarized radiation and receiving different information conveyed over the left hand circularly polarized radiation. A second operational mode of the system may involve receiving radiation from multiple elements of the terrestrial multiple sector antenna.

Yet another method according to the present invention involves: defining a modulation scheme in response to an expected communication load and in response to an expected signal to noise ratio within a beam area defined by a satellite beam; and transmitting multiple modulated information streams over multiple satellite beams wherein the information streams are modulated in response to the modulation scheme; wherein the multiple satellite beams have substantially the same cross section and adjacent satellite beams convey information over different sets of carrier frequencies. The modulation scheme may include defining more robust modulations to areas located more remotely from a coastline. The present method may further involve transmitting information streams over terrestrial links using carrier frequency sets that partially overlap at least one carrier frequency set of a satellite beam; and/or transmitting at least one modulated information stream using a first polarization (e.g., a right-hand circular polarization) and using an orthogonal polarization for transmitted another modulated information stream.

### BRIEF DESCRIPTION OF THE DRAWINGS

The present invention will be understood and appreciated more fully from the following detailed description taken in conjunction with the following figures, in which:

FIG. 1 illustrates an exemplary device configured according to an embodiment of the invention;

FIG. 2 illustrates a method for transmission according to an embodiment of the invention;

FIG. 3 illustrates two networks configured according to an embodiment of the invention;

FIG. 4 illustrates a terrestrial antenna and a satellite antenna each configured according to an embodiment of the invention;

FIGS. 5 and 6 illustrate cross sectional views of an antenna unit configured according to an embodiment of the invention;

FIG. 7 illustrates a method according to an embodiment of the invention;

FIG. 8 illustrates a method according to another embodiment of the invention;

FIG. 9 illustrates a method according to a further embodiment of the invention;

FIG. 10a illustrates a population distribution in the United States;

FIG. 10b illustrates an exemplary frequency re-use scheme according to an embodiment of the invention;

FIG. 11 illustrates a method according to an embodiment of the invention;

FIG. 12 illustrates a timing diagram according to an embodiment of the invention;

FIG. 13 illustrates an exemplary a timing diagram that shows the timing gaps between the reception and transmissions of frames over a satellite link;

FIG. 14 illustrates a method according to an embodiment of the invention;

FIG. 15 illustrates a further method according to an embodiment of the invention;

FIG. 16 illustrates yet another method according to an embodiment of the invention;

FIG. 17 illustrates still another method according to an embodiment of the invention; and

FIG. 18 illustrates a pair of frames where the area covered by the satellite beam includes two groups of devices, according to an embodiment of the invention.

### DETAILED DESCRIPTION

The present invention is described with reference to several figures that illustrate exemplary embodiments of the invention. These illustrations are not intended to limit the scope of the invention but rather to assist in understanding some of the embodiments of the invention.

According to an embodiment of the invention a device and method for transmitting information over a satellite link using WiMAX technology is provided. In particular, a device and method capable of both WiMAX terrestrial transmission and satellite link transmission is provided. In various countries, including Canada and the United States of America, vendors are permitted to provide ancillary terrestrial mobile services as a part of mobile satellite service offerings. The available bands can include, for example 1525-1559 MHz 1525-1669 Mhz, 1626.5-1660.5 Mhz, 1610-1626.5 Mhz, 2483.5-2500 Mhz, 1990-2025 Mhz., and 2483.5-2500 Mhz., but this is not necessarily so. The satellite link differs from a terrestrial WiMAX link by various characteristics, including delay (propagation) periods, path attenuation, bandwidth and the like. Accordingly, the suggested transmitter should alter the modulation, media access control and transmission parameters in response to the selected transmission link characteristics.

When using the satellite link, the device uses a relatively simple and more robust modulation scheme. The MAC layer grants access to the shared media in a less dynamic manner. This is not necessarily so. It is noted that the uplink modulation can differ from the downlink modulation. For example, more robust modulation can be used for uplink transmission in comparison to downlink modulation.

A WiMAX MAC layer, when executing WiMAX MAC schemes for the terrestrial WiMAX link, operates on a frame to frame basis. That MAC layer, when executing MAC schemes for the satellite link, operates on a multi-frame basis. It can still perform MAC allocation on a frame to frame basis but takes into account longer periods. The suggested device includes PHY layer and MAC layer chips that are adapted to adjust the transmission, modulation and MAC parameters to the various selected link characteristics.

The development of a single, dual purpose WiMAX device can be cheaper than developing a dedicated WiMAX terrestrial device and a dedicated WiMAX satellite device. Conveniently, most of the WiMAX components and layers can remain unchanged.

The PHY layer and MAC layer chips operate substantially unchanged although the different characteristics associated with satellite transmissions. In order to respond to the delay variations associated with transmissions from (or to) devices located in a large area covered by a beam, a system such as a base station, can define different range determination windows. Method 600 illustrates an exemplary method that overcomes these delay variations. The delay variations within an area covered by a single beam are also managed by method 900 and 1000 that enable to define the timing of uplink and downlink frames in response to this delay variation.

In order to cope with the large (multi-frame) round-trip delays associated with satellite transmission various alternative methods (such as methods 700 and 800) are provided to configure a receiver, although the WiMax compliant MAP messages define transmission characteristics for one or more frame.

One other aspect of the invention is the ease of installation of devices. By using a fixed antenna configuration as well as providing a radome that includes directional information the device can be installed by a layman, thus substantially reducing the cost of installation.

Yet according to another embodiment of the invention the satellite links are used in a very efficient manner, thus allowing to re-use frequency sets to cover the United States. Alternatively or additionally the throughput of the system is increased by using different mutually orthogonal polarizations to convey different information streams concurrently.

It is noted that various re-use factors (such as 7.9 or other re-use factors) can be used, depending upon the isolation between adjacent beams (which is driven from beam shaping characteristic of the satellite transmitter antenna) the required modulation scheme (mainly on the downlink) and the required performance in terms of Es/No for proper operation of the required modulation scheme.

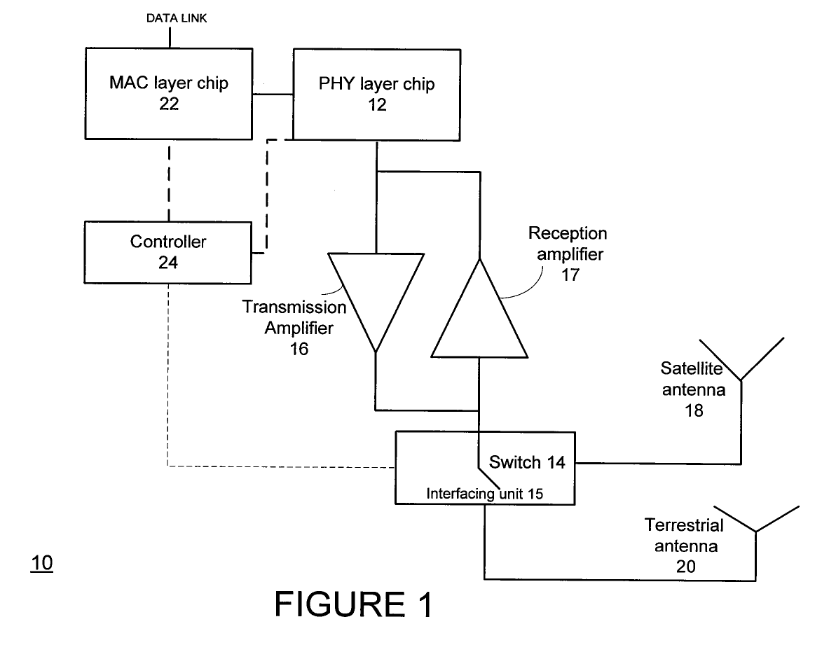

FIG. 1 illustrates a portion of a device 10, according to an embodiment of the invention. Device 10 can transmit over terrestrial links and over satellite links. Device 10 can also receive information that is being transmitted over satellite links or over terrestrial links.

Device 10 includes a RF chip 12 that is connected, via a switch 14, either to a terrestrial transmission/reception path or to a satellite transmission/reception path. The transmission/reception path can include an transmission amplifier 16 a reception amplifier 17 and an antenna. The antenna is selected by a switch 14 controlled by the controller 24 to be satellite antenna 18, or terrestrial antenna 20. It is noted that each path can include additional (or less) components such as filters, amplifiers, and the like. According to an embodiment of the invention each antenna is used both for reception and transmission; though this is not necessarily so. According to another embodiment of the invention each path can include components that are dedicated to reception or to transmission, but this is not necessarily so. Usually it is more cost effective to use as many components and circuitry for both transmission and reception.

The RF chip 12 is connected to a MAC layer chip 22. Both chips can be integrated in a single integrated circuit. Both chips 12 and 22 are controlled by controller 24 that determines in which mode (satellite or terrestrial) to transmit and to receive. The RF chip 12, the MAC layer chip 22 and the controller 24 can be integrated into a single chip.

Conveniently, the RF chip 12 receives data signals and performs up-conversion and modulation. The RF chip also receives RF signals from the link, performs down-conversion and demodulation. The MAC layer chip 22 is connected, usually via a wired link, to multiple indoor devices such as multimedia devices, computers, game consoles and the like. MAC layer chip 22 can also be connected to or be a part of a mobile device. The mobile device can be a cellular phone, personal data accessory, lap top and the like. The mobile device can be connected, via one or more wires, to an WiMAX/satellite antenna, and/or a WiMAX/satellite transceiver. A USB interface or any other conventional interface can be used for connecting the mobile device to the WiMAX components.

The controller 24 can also determine the parameters of the modulation and the transmission, as well as the parameters of the reception and the de-modulation. The determination can be predefined or responsive to various link characteristics such as SNR, bandwidth and the like.

The inventors found that the device can use multiple access schemes such as OFDM and OFDMA, and modulation (and de-modulation) schemes such as 64QAM, 16QAM, QPSK and BPSK when performing terrestrial and/or satellite links. It is noted that other modulations and de-modulation schemes can also be applied.

According to an embodiment of the invention some downlink as well as uplink transmission can utilize only a small portion of the frequency carriers available for OFDM transmission. This is also known as performing sub-channeling. This allows to substantially reduced interferences.

According to an embodiment of the invention the satellite antenna is placed above the terrestrial antenna, but other arrangements can be applied.

According to an embodiment of the invention a device that is allowed to use the satellite link for WiMAX transmissions should also be able to use the satellite link for other services. Accordingly, the dual device 10 can use the satellite link for transmitting and receiving information for other applications than WiMAX transmissions.

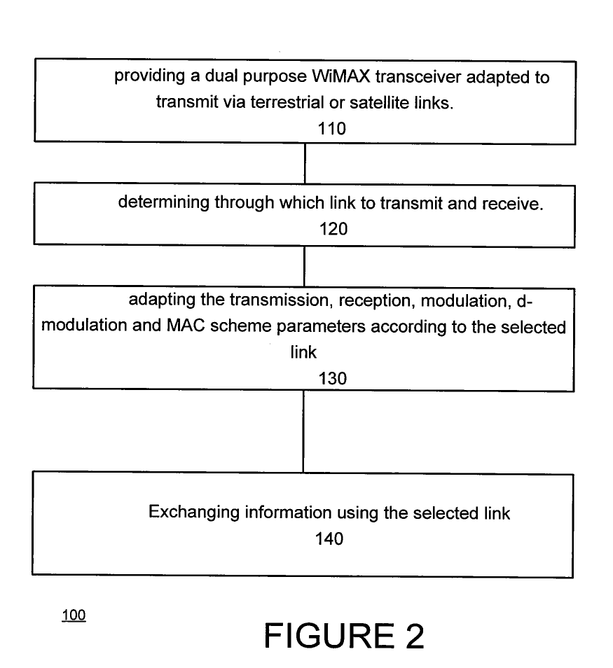

FIG. 2 illustrates a method 100 for transmitting and receiving information using a satellite link or a terrestrial link. Method 100 starts by stage 110 of providing a dual purpose WiMAX transceiver adapted to transmit via terrestrial or satellite links. Stage 110 is followed by stage 120 of determining through which link to transmit and receive. Stage 120 is followed by stage 130 of adapting the transmission, reception, modulation, de-modulation and MAC scheme parameters according to the selected link. Stage 130 is followed by stage 140 of exchanging information using the selected link. According to an embodiment of the invention device 10 can use both links, either by performing time domain multiplexing or frequency domain multiplexing. In the latter case more reception and transmission circuitry can be required. According to an embodiment of the invention stage 130 can include selecting whether to operate at TDD, FDD or H-FDD.

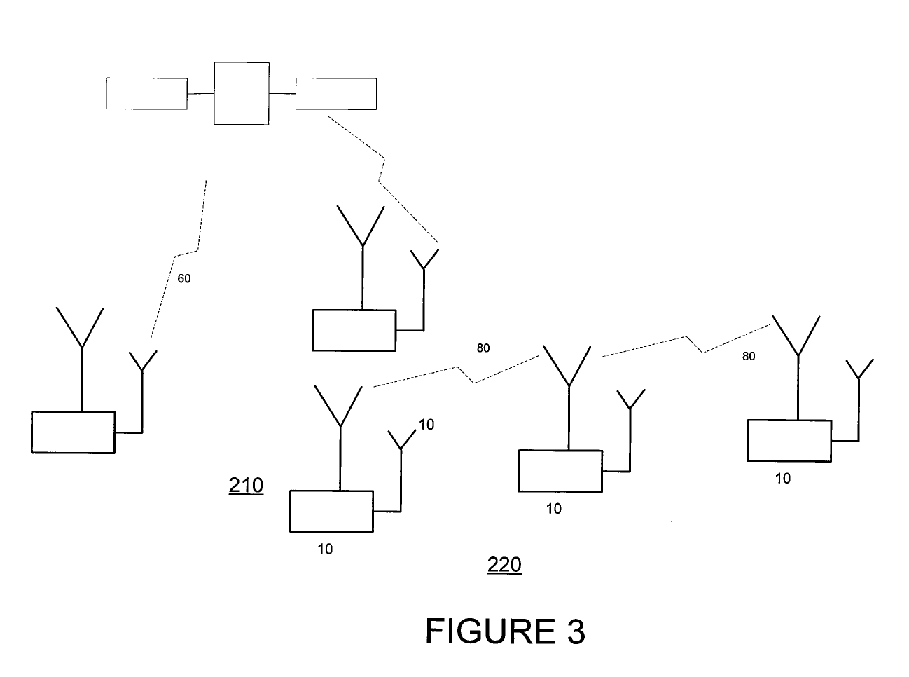

FIG. 3 illustrates a first network 210 that includes multiple devices 10 that exchange information via satellite links 60 and a second network 220 that include multiple devices 10 that exchange information via terrestrial links 80. Typically the devices of a certain WiMAX network use the same link type. It is further noted that other networks configurations are available, such as networks that include a mobile device connected to or including a WiMAX transceiver (and/or WiMAX antenna).

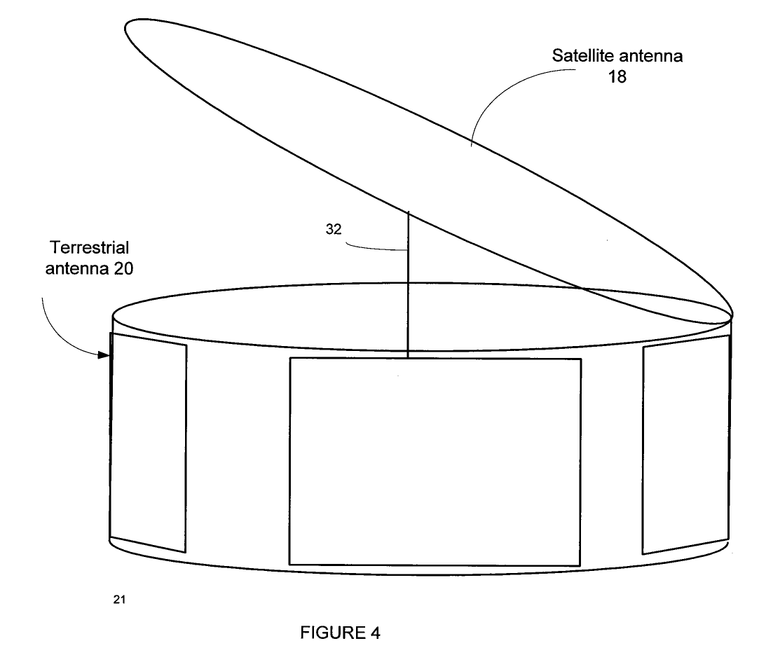

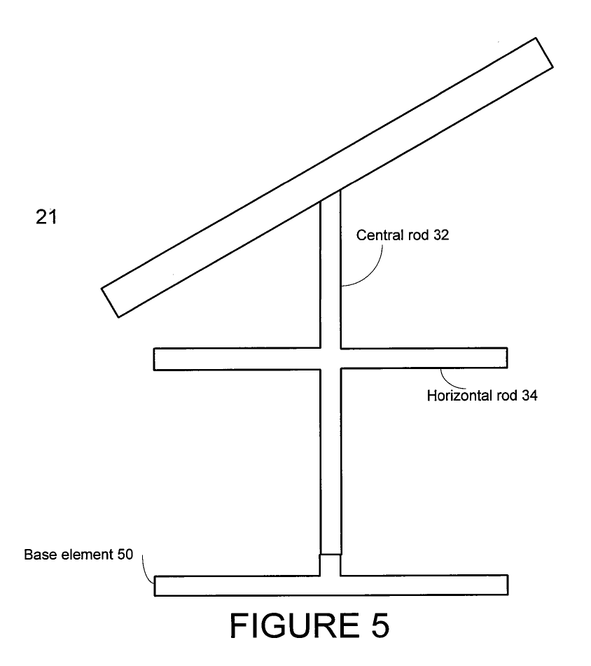

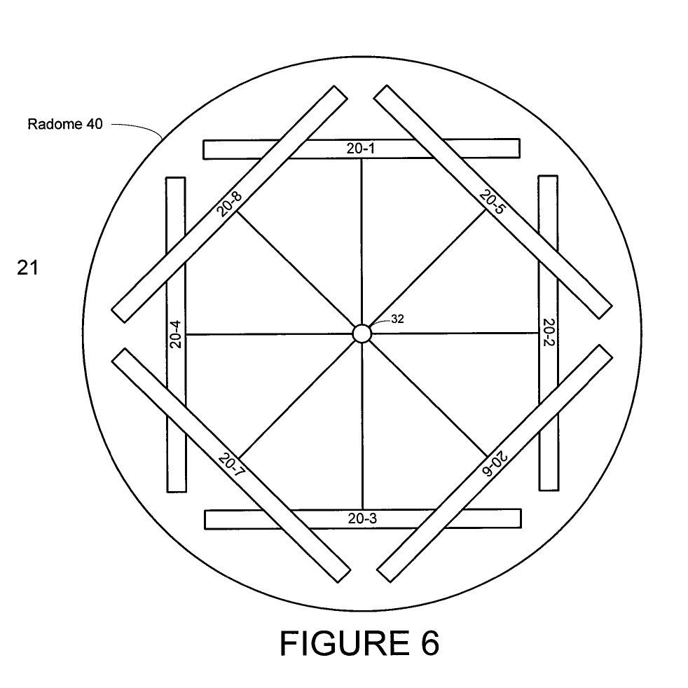

FIG. 4 illustrates a terrestrial antenna 20 and a satellite antenna 18, according to an embodiment of the invention. FIGS. 5 and 6 illustrate cross sectional views of an antenna unit 21. The satellite antenna 18 conveniently points towards the corresponding Geostationary satellite through manual, mechanical, or electrical steering, and using either open loop, or closed loop adjustment. The inventors use a fixed satellite antenna oriented at an angle of 40 degrees such as to receive transmissions from a satellite beam that spans between latitudes 23.3 and 59.9 degrees. The terrestrial antenna 18 is conveniently a WiMAX multi sector antenna.

Conveniently, satellite antenna 18 is adapted to receive right hand circularly polarized radiation and left hand circularly polarized radiation over a satellite link. Conveniently, satellite antenna 18 is oriented in relation to an imaginary vertical axis (illustrated by dashed line 19) that is substantially parallel to multiple elements of the terrestrial multiple sector antenna.

Conveniently, the satellite antenna 18 is connected to a structural element that includes a central rod 32 as well as one or more horizontal rods 34 that connect the central rod 32 to each of the elements 20-1-20-8 of the terrestrial multiple sector antenna 20. The central rod 32 can be pivotally mounted to base element 50.

The inventors used a terrestrial antenna 20 that had eight antenna elements. Four antenna elements were oriented at 0, 90, 180 and 270 degrees, while four antennal elements were oriented at 45, 135, 215 and 305 degrees. It is noted that the number of antenna elements, the shape of each antenna element, the angular range covered by each antenna element as well as the relative position of the antenna elements in relation to each other can differ from those illustrated in FIGS. 5 and 6. For example, a terrestrial antenna can include four antenna elements with 90 degrees between them on one level, and another four element antennas positioned on another level, wherein the four other antenna elements are oriented by 45 degrees in relation to the first four antennas.

The beam forming can be such that each element is used solely for transmission/reception to one of the eight directions. The beam forming can be such that two or more elements are combined in phase to produce a radiation pattern to each of the eight directions. That is, to create a radiation pattern to a selected direction, two or more elements will be used, combined together in phase. To create a radiation pattern to another selected directions, a combination of other two or more elements will be used. The terrestrial antenna is also supporting omni directional beam, by combining all the terrestrial antenna elements together.

Conveniently, the satellite antenna 18, the terrestrial antenna 20 are surrounded (or at least partially surrounded) by radome 40. Conveniently, the radome 40 is fixed to the structural element, so that when the radome 40 rotates the structural element (as well as antennas 18 and 20) rotate. The structural element and/or the radome 40 can be pivotally connected to base element 50. The base element 50 can be fixed to a rooftop or another stationary element.

According to an embodiment of the invention location information is printed on an external surface of the radome 40. Different location information can be printed on different positions (that correspond to different angles in relation to an imaginary center of the radome) of radome 40, thus allowing to direct the antenna unit 21 towards a required direction (that corresponds to a location of the satellite) by rotating the radome until a location indication printed on radome 40 is directed towards a predefined direction (that can be determined by using, for example, a compass).

The location information can include the name of cities, states, countries and the like (or longitude, altitude coordinates). The location information printed on a radome sold in New York can differ from the location information printed on a radome sold in Los Angeles, but this is not necessarily so. According to another embodiment of the invention the same location information can be used in different locations.

The antenna unit 21 defines multiple reception (an/or transmission) paths. Satellite antenna 20 can receive both right hand circularly polarized radiation and left hand circularly polarized radiation thus can define two radiation paths. Each antenna element (sector) 20-1-20-8 of terrestrial antenna 20 can define its own reception paths. It is noted that the radiation received by two or more antenna elements 20-n can be combined prior to being received by other elements (such as a receiver front end) or system 10. It is further notes that satellite antenna 18 as well as terrestrial antenna 20 can be used for transmitting information. Multiple antenna elements 20-n of terrestrial antenna 20 can transmit the same information.

Accordingly, switch 14 can be included within an interfacing unit 15 (see FIG. 1) that can switch between the terrestrial antenna to the satellite antenna 18, and also pass (output) radiation from one or more (two in the case of satellite antenna 18) reception paths. Interfacing unit 15 is adapted to selectively output radiation received by at least one receiving element out of the satellite antenna and an antenna element of the terrestrial multiple sector antenna 20.

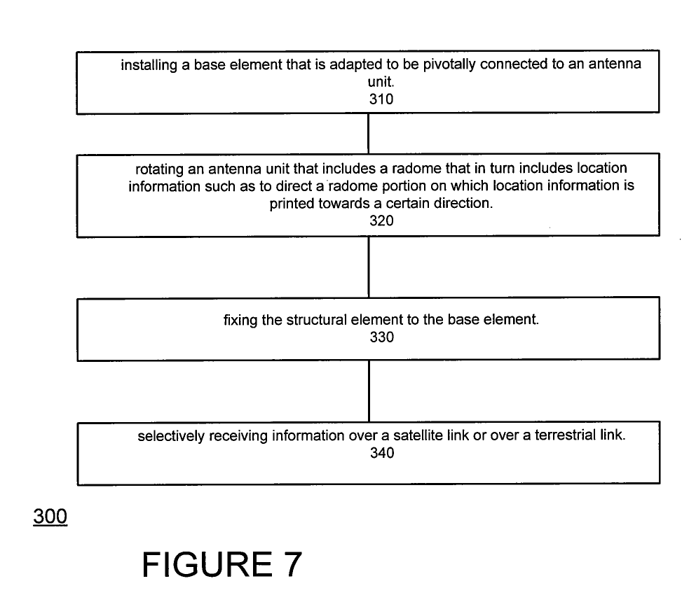

FIG. 7 illustrates method 300 according to an embodiment of the invention. Method 300 starts by stage 310 of installing a base element that is adapted to be pivotally connected to an antenna unit. The base element can be already connected to the antenna unit when it is installed but this is not necessarily so and it can be connected to the antenna unit after being installed.

Stage 310 is followed by stage 320 of rotating the antenna unit 21 that includes a radome that in turn includes location information such as to direct a radome portion on which location information is printed towards a certain direction. Conveniently, the antenna unit 21 includes a satellite antenna such as satellite antenna 18 adapted to receive right hand circularly polarized radiation and left hand circularly polarized radiation over a satellite link and a terrestrial multiple sector antenna such as terrestrial antenna 20 that is adapted to receive terrestrial communication. Conveniently, stage 320 includes determining the certain direction by using a low cost direction finding unit such as a compass.

Stage 320 is followed by stage 330 of fixing the structural element to the base element. Stage 330 is followed by stage 340 of selectively receiving information over a satellite link or over a terrestrial link.

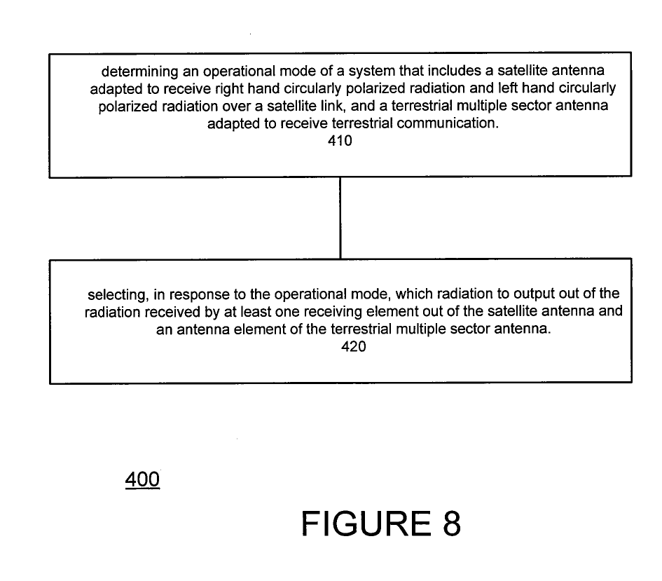

FIG. 8 illustrates method 400 according to an embodiment of the invention. Method 400 starts by stage 410 of determining an operational mode of a system that includes a satellite antenna adapted to receive right hand circularly polarized radiation and left hand circularly polarized radiation over a satellite link, and a terrestrial multiple sector antenna adapted to receive terrestrial communication.

Stage 410 is followed by stage 420 of selecting, in response to the operational mode, which radiation to output out of the radiation received by at least one receiving element out of the satellite antenna and an antenna element of the terrestrial multiple sector antenna. This selection can involve configuring interfacing unit 15 to output radiation from one or more antenna or antenna element. It is noted that interface unit 15 may include switches, phase combiners etc.

Conveniently, a first operational mode includes receiving information conveyed over the right hand circularly polarized radiation and receiving different information conveyed over the left hand circularly polarized radiation. Conveniently, a second operational mode comprises receiving radiation from multiple elements of the terrestrial multiple sector antenna.

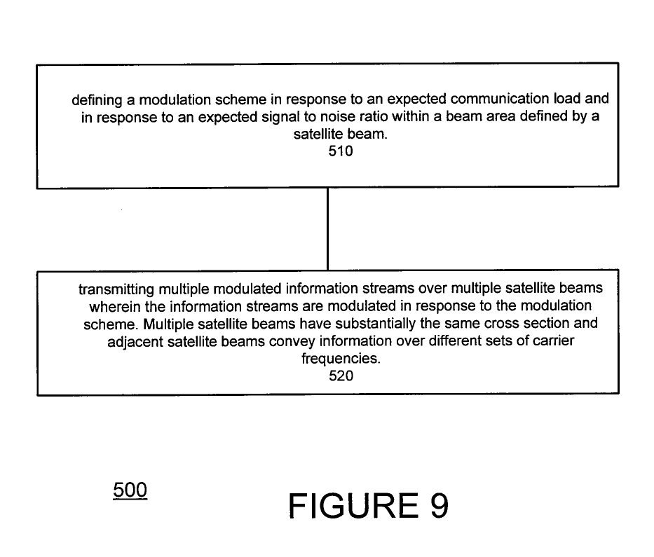

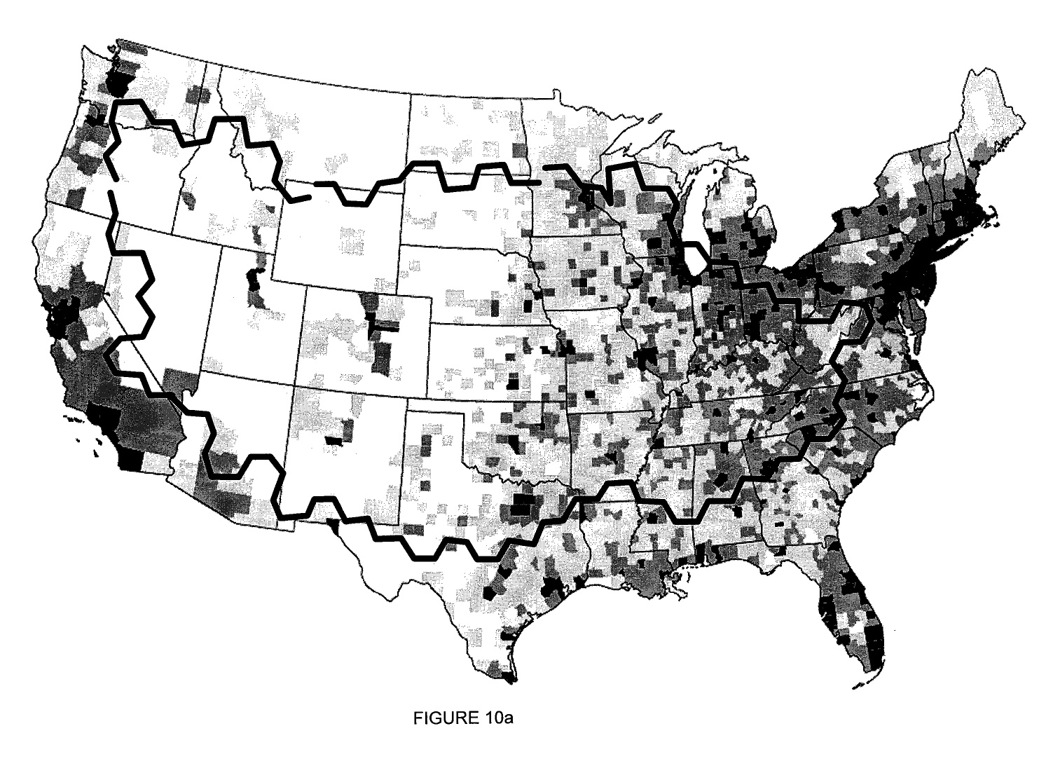

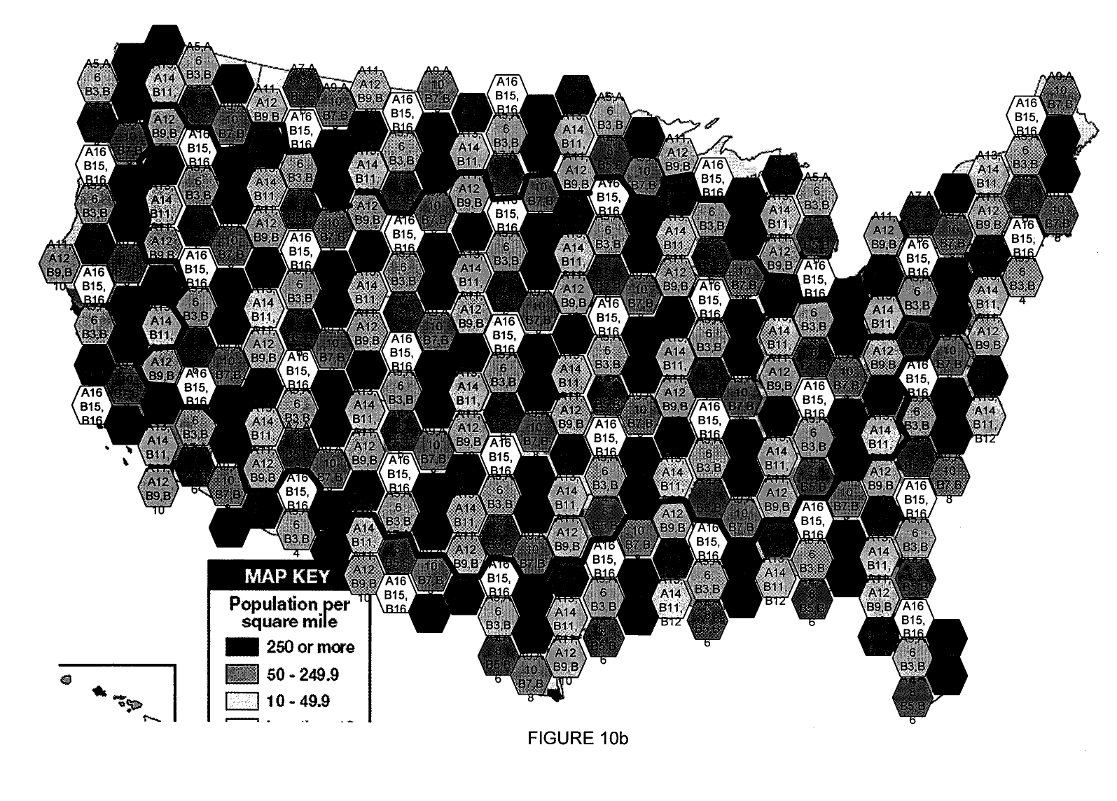

FIG. 9 illustrates method 500 according to an embodiment of the invention. FIG. 10a illustrates a population distribution in the United States. It shows that most of the population is concentrated near the coast. FIG. 10b illustrates an exemplary frequency re-use scheme 590 according to an embodiment of the invention. The frequency re-use scheme illustrates multiple evenly shaped beams that cover the area of the United States.

Method 500 includes stage 510 of defining a modulation scheme in response to an expected communication load and in response to an expected signal to noise ratio within a beam area defined by a satellite beam. Referring to frequency re-use scheme 590, the beams that are closer to the coastlines use a less robust but higher throughput modulation. Stage 510 is followed by stage 520 of transmitting multiple modulated information streams over multiple satellite beams wherein the information streams are modulated in response to the modulation scheme. Multiple satellite beams have substantially the same cross section and adjacent satellite beams convey information over different sets of carrier frequencies.

Most of the population as well as the larger demand for services originate along the coastline of the United States of America. In addition, satellite beams directed towards costal areas are surrounded by fewer beams (as fewer or even no satellite beams are not allocated for naval transmissions, and the density of naval users is dramatically smaller than those of terrestrial users), thus they suffer from fewer interferences and accordingly are characterized by higher signal to noise and/or interference ratio that enable to use less robust (but higher throughput) modulation schemes.

For example, by using a frequency re-use factor of nine the entire United States can be covered using beams of about 243 kilometers in diameter. Beams that are closer to costal areas can be surrounded by six or even fewer beams, while in land beams are surrounded by up till eight beams. Thus, more robust modulation schemes (such as downlink modulations of 16 QAM, with FEC rate ½) can be used in in-land territories while higher throughput modulations (such as downlink modulation 64 QAM, with FEC rate ⅔) can be used in coastal areas.

Conveniently, the modulation scheme includes defining more robust modulations to areas that are more remote from a coastline.

Conveniently, stage 520 includes transmitting information streams over terrestrial links using carrier frequency sets that partially overlap at least one carrier frequency set of a satellite beam.

U.S. Pat. No. 6,892,068 of Karabinis et el., entitled “Coordinated satellite-terrestrial frequency re-use”, which is incorporated herein by reference, discloses methods and systems for re-using satellite frequencies and frequency sets. Some of these frequency sets can also be used to transmit information to different devices.

Conveniently, stage 520 includes transmitting at least one modulated information stream using a first polarization and using an orthogonal polarization for transmitted another modulated information stream. Conveniently, these polarizations can be elliptical polarizations. These elliptical polarizations include linear polarizations, circular polarization and the like.

Assuming that the satellite beam is 243 kilometer in diameter, that the satellite is positioned at orbiter position of 107.3, that the height of the satellite is 36,000 kilometers then the delay variations associated with a transmission to and from the device within an area spanned by the satellite beam is bounded from above by 1.6 mili-seconds.

A WiMax device establishes a link with a base station (using terrestrial links) by receiving synchronization messages from the base station and in response transmitting identification information to the base station. The base station opens range determination windows that their length is responsive to the delay variation expected over terrestrial links. Due to the substantially smaller length of terrestrial transmissions links WiMax compliant range determination windows are much shorter than those required for determining the range of devices that communicate with the base station using satellite links. Thus, the length of a WiMax range determination window is much shorter than 1.6 mili-seconds.

For example, a standard WiMax ranging opportunity window includes two symbols. Where a typical WiMax symbol period is 100 micro-seconds. Particularly, some WiMax chips limit the ranging opportunity to be of maximal length of three couples of two OFDMA symbols. Which particularly translates to 600 micro-seconds. This statement is only an example, and can be any other number.

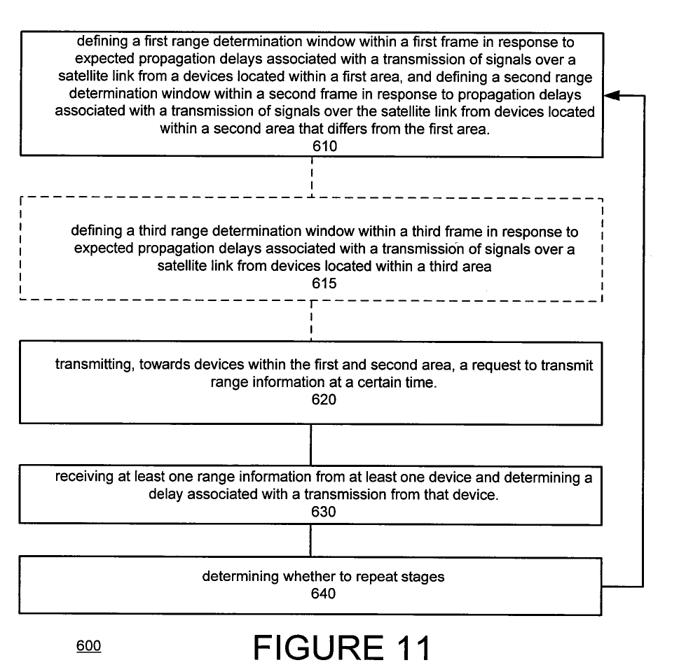

In order to overcome this limitation method 600 (illustrated in FIG. 11) is provided. By opening different range determination windows the base station can receive transmissions from different devices. Method 600 can be executed by WiMax devices without changing their MAC layer. Only the base station has to define different range reception windows.

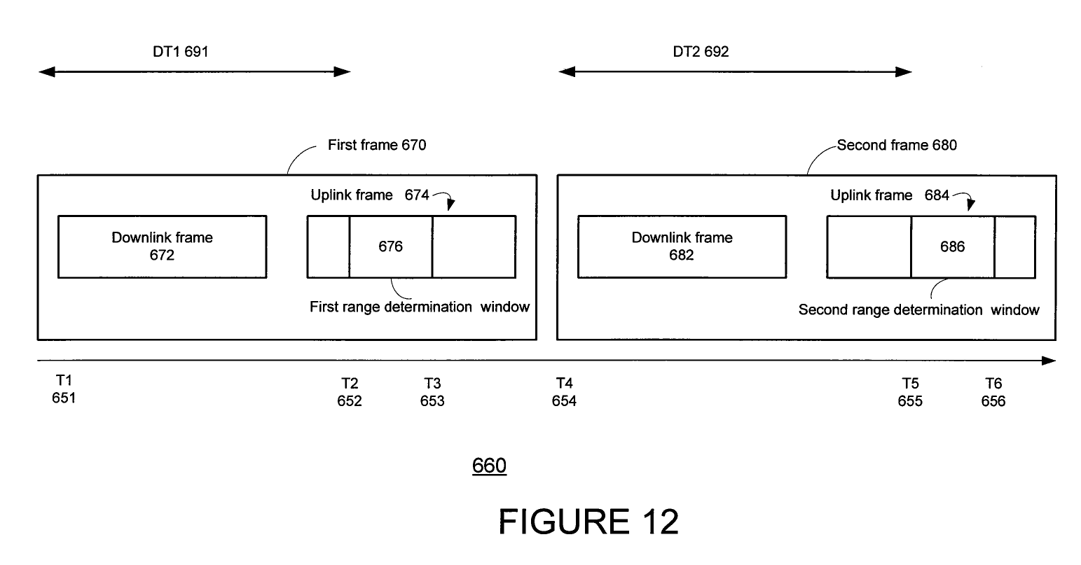

FIG. 12 illustrates an exemplary timing diagram 660 according to an embodiment of the invention. Timing diagram 660 illustrates two frames 670 and 680. First frame 670 starts by a downlink frame 672 that is followed by a guard time and an uplink frame 674. The uplink frame 674 includes a first range determination window 676. Second frame 680 starts by a downlink frame 682 that is followed by a guard time and an uplink frame 684. The uplink frame 684 includes a second range determination window 686. Both range determination windows are illustrated as having the same length but this is not necessarily so.

The first time frame 670 starts at T1 651. The first range determination window 676 starts at time T2 652 and ends at time T3 653. The second time frame 680 starts at T4 654. The second range determination window 686 starts at time T5 655 and ends at time T5 656.

A first timing offset DT1 691 between the start (T1 651) of the first frame 670 and the start (T2 652) of first range determination window 676 differs from a second timing offset DT2 692 between the start (T4 654) of second frame 680 and the start (T5 655) of second range determination window 686. This scheme extends the overall area that can be properly covered by the satellite, as link establishment transmissions from devices that are located in different distances from the satellite can be discovered in the first or second range determination windows.

Method 600 starts by stage 610 of defining a first range determination window within a first frame in response to expected propagation delays associated with a transmission of signals over a satellite link from a devices located within a first area, and defining a second range determination window within a second frame in response to propagation delays associated with a transmission of signals over the satellite link from devices located within a second area that differs from the first area.

It is noted that method 600 can include allocating multiple range determination windows that can be schedules to receive transmissions from different areas. For example, if a third area exists (that differs from the first and second areas is also defined) than method 600 can also include stage 615 of defining a third range determination window within a third frame in response to expected propagation delays associated with a transmission of signals over a satellite link from devices located within a third area. In such a case stage 620 will include transmitting, towards devices within the third area, a request to transmit range information at a certain time.

Conveniently, stage 610 includes defining the first range determination window and the second range determination window such that a first timing offset between a start of the first frame and a start of the first range determination window differs from a second timing offset between a start of the second frame and a start of the second range determination window. This scheme extends the overall area that can be properly covered by the satellite, as link establishment transmissions from devices that are located in different distances from the satellite can be discovered in the first or second range determination windows.

Conveniently, stage 610 includes defining the first range determination window and the second range determination window such that the second timing offset is larger than the first timing offset and is smaller than a sum of the first timing offset and a length of the first range determination window. This scheme can be applied when the first and second areas partially overlap, or when the satellite is located at the same distance from a first device within the first area and from a second device within the second area.

Conveniently, stage 610 includes defining the first range determination window and the second range determination window such that the second timing offset is larger than a sum of the first timing offset and a length of the first range determination window. This scheme can be applied when the first and second areas do not overlap, or when devices within the first area are located at different distances from the satellite in relation to the distances between devices of the second area and the satellite. This scenario can be applied, for example, when the second area surrounds the first area.

Stage 610 is followed by stage 620 of transmitting, towards devices within the first and second area, a request to transmit range information at a certain time. Conveniently, stage 620 includes transmitting, towards devices within the first area the request to transmit range information at the certain time, using a first set of frequencies, and transmitting, towards devices within the second area the request to transmit range information in at the certain time, using a second set of frequencies.

Stage 620 is followed by stage 630 of receiving at least one range information from at least one device and determining a delay associated with a transmission from that device.

Stage 630 is followed by stage 640 of determining whether to repeat stages 610-630. The determination can be responsive to a control parameter. Typically, stages 610-630 are constantly repeated.

WiMax base stations and devices exchange information over terrestrial links that is managed by the base station. The base station sends MAP messages that define receiver and transmitted configuration for uplink and downlink transmission. A typical MAP message can define this configuration (for example, modulation scheme, error correction code type, error correction code rate, and the like) for one or two frames. Each frame includes uplink and downlink transmission as well as guard periods and is 5 to 20 mili-second long. A base station usually sends a downlink frame towards a device that in turn can respond by uplink transmitting during the same frame or at the next frame.

The round trip delay associated with satellite transmission is very large compared with the round trip delay associated with terrestrial transmission. An exemplary round-trip associated with a satellite that is positioned 36,000 kilometers above Earth at orbital position 107.3 is about 500 mili-seconds. Thus, about twenty five frames (of 20 mili-second each, and much more frames are transmitted during the round trip if the frame length is 5 mili-second) will pass between (i) the transmission of a MAP message from a base station via a satellite to a device and (ii) a reception of the uplink transmission from that device.

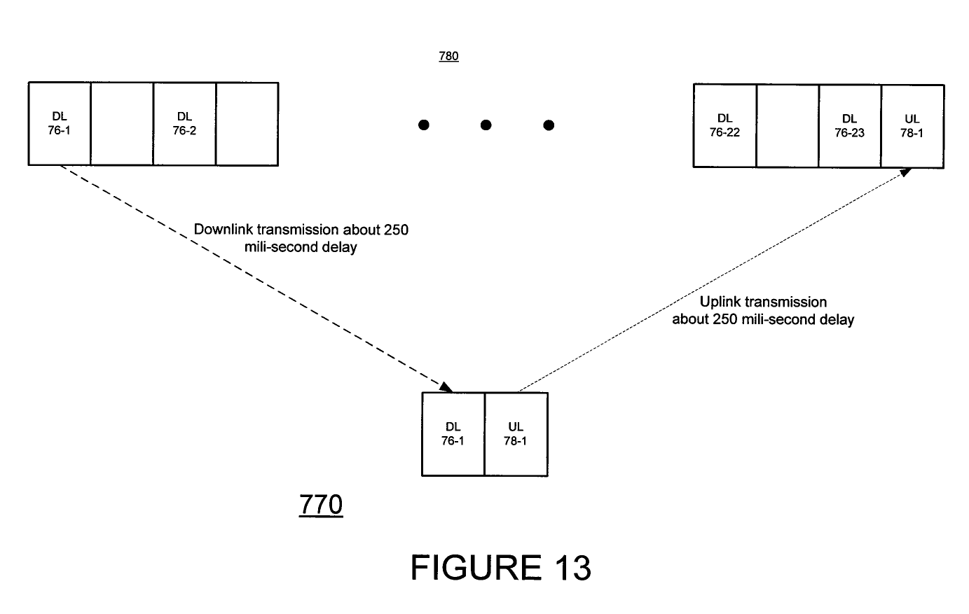

FIG. 13 illustrates an exemplary timing diagram 770 that shows the timing gaps between the reception and transmissions of frames over a satellite link.

The upper portion of FIG. 13 illustrates a sequence 780 of downlink (DL) frames 76-j and uplink (UL) frames 78-k. Each frame can correspond to frames 670 and 680 of FIG. 12. Each frame includes a downlink frame (that includes a MAP message) as well as time allocated for uplink transmission. A first downlink frame 76-1 is downlink transmitted from a base station via a satellite towards a certain device. This downlink frame is received by that certain device after a one way delay of about 250 mili-seconds. Assuming that certain device responds (by uplink transmission illustrated by uplink frame 78-1) during that time frame, then this transmission is received by the base station after about 500 mili-seconds. When this frame is received the base station receiver should be configured according to the MAP message that was sent 500 mili-seconds ago. Methods 700 and 800 compensate for these timing differences. They enable to use WiMax compliant device substantially unchanged. The base station can be slightly changed by including a larger memory unit or by having a software layer that correlates between devices and transmissions.

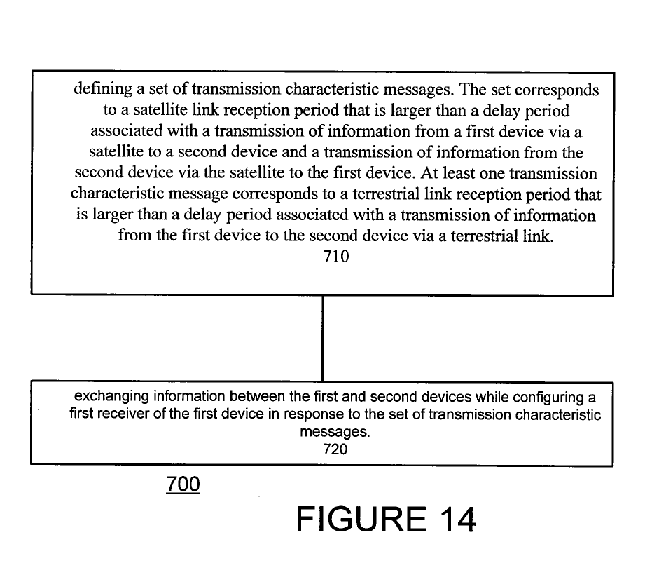

FIG. 14 illustrates method 700 according to an embodiment of the invention. Method 700 starts by stage 710 of defining a set of transmission characteristic messages. The set corresponds to a satellite link reception period that is larger than a delay period associated with a transmission of information from a first device via a satellite to a second device and a transmission of information from the second device via the satellite to the first device.

At least one transmission characteristic message defines transmission characteristics during a period that corresponds to a terrestrial link reception period that is smaller than a delay period associated with a transmission of information from the first device to the second device via a terrestrial link.

Stage 710 is followed by stage 720 of exchanging information between the first and second devices while configuring a first receiver of the first device in response to the set of transmission characteristic messages. Conveniently, the satellite link reception period is much larger than the terrestrial link reception period. Conveniently, at least one transmission characteristic message defines reception characteristics during fewer than three transmission frames. Conveniently, stage 720 is preceded by a stage of determining the satellite link reception period. This stage can involve applying one or more stages of method 600.

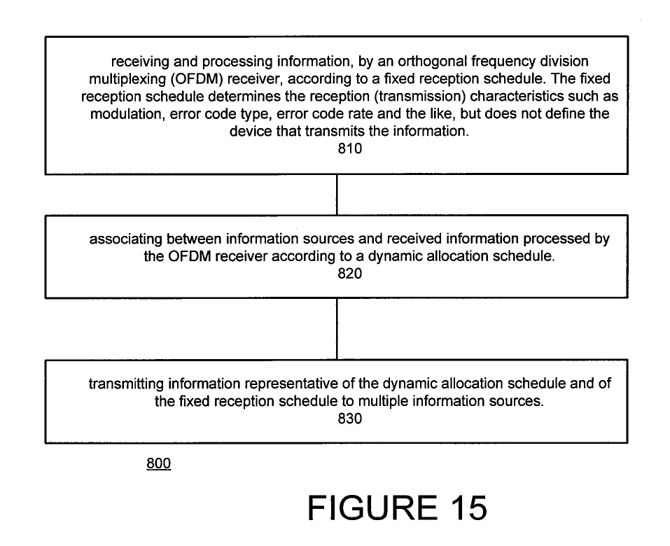

FIG. 15 illustrates method 800 according to an embodiment of the invention. Method 800 starts by stage 810 of receiving and processing information, by an orthogonal frequency division multiplexing (OFDM) receiver, according to a fixed reception schedule. The fixed reception schedule determines the reception (transmission) characteristics such as modulation, error code type, error code rate and the like, but does not define the device that transmits the information.

Stage 810 is followed by stage 820 of associating between information sources and received information processed by the OFDM receiver according to a dynamic allocation schedule. Conveniently, the ODFM receiver includes a WiMax compliant chipset. The dynamic allocation scheme determines which device transmitted the received information. Prior to transmission frames a base station (or other system) can send information that determines the timing of device transmissions as well as the transmission characteristics, this information can be determines by software or middleware without altering existing hardware. In this scenario the existing hardware is fed with the fixed reception schedule but is not aware of the dynamic allocation between transmissions and devices.

Conveniently, stage 820 includes utilizing a software layer or a middleware layer. Stage 820 is followed by stage 830 of transmitting information representative of the dynamic allocation schedule and of the fixed reception schedule to multiple information sources.

Due to the delay variance some devices, especially those characterized by larger delays, practically have a narrower uplink window than the uplink windows of devices that are characterized by lower delay. There is a need to broaden the actual uplink window of devices. Conveniently this is executed by allowing some devices to start upstream transmission before they receive the end of the downlink frame. In order to prevent these devices from missing relevant information the end of the downlink frame does not include information aimed to these devices.

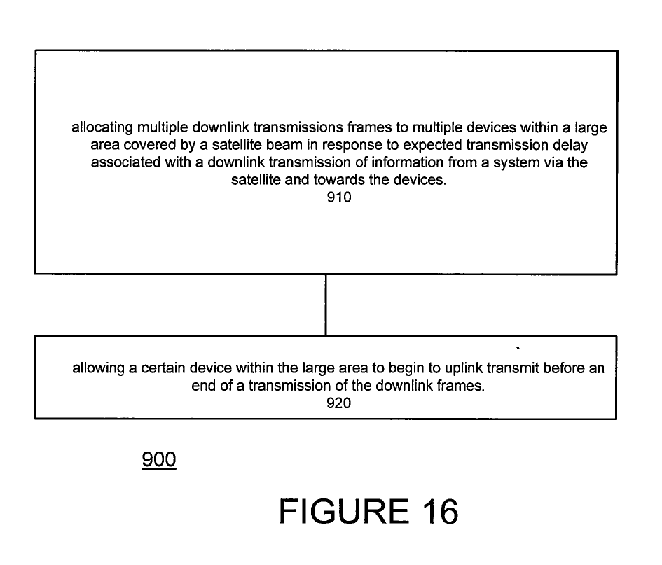

FIG. 16 illustrates method 900 according to an embodiment of the invention. Method 900 starts by stage 910 of allocating multiple downlink transmissions frames to multiple devices within a large area covered by a satellite beam in response to expected transmission delay associated with a downlink transmission of information from a system via the satellite and towards the devices.

Conveniently, stage 910 includes allocating at least one downlink transmission frame to the certain device such that that at least one downlink transmission frame is received by the certain device prior to a beginning of the uplink transmission.

Conveniently, a time difference between the beginning of the uplink transmission and the end of the multiple downlink transmission frames is responsive to the expected transmission delay associated with an uplink transmission from the certain device via the satellite and towards the system.

Stage 910 is followed by stage 920 of allowing a certain device within the large area to begin to uplink transmit before an end of a transmission of the downlink frames.

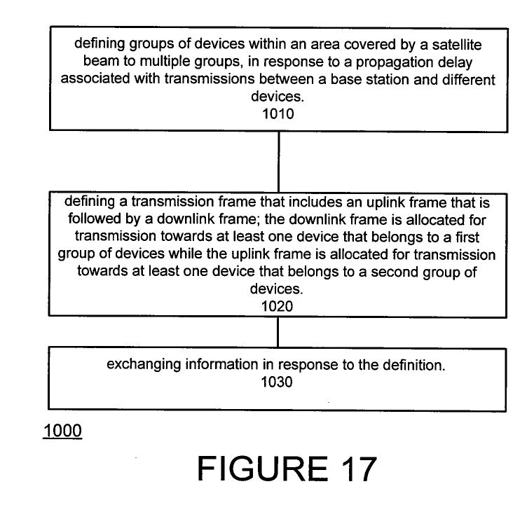

FIG. 17 illustrates method 1000 according to an embodiment of the invention. Method 1000 starts by stage 1010 of defining groups of devices within an area covered by a satellite beam to multiple groups, in response to a propagation delay associated with transmissions between a base station and different devices. Stage 1010 include

Stage 1010 is followed by stage 1020 of defining a transmission frame that includes an uplink frame that is followed by a downlink frame. The downlink frame is allocated for transmission towards at least one device that belongs to a first group of devices while the uplink frame is allocated for transmission towards at least one device that belongs to a second group of devices.

Conveniently, stage 1020 is repeated to define multiple transmission frames. Each group of devices is associated with a pair of uplink frame and downlink frame but these frames do not appear in the same frame. It is noted that the area can include two or more device groups. Stage 1020 is followed by stage 1030 of exchanging information in response to the definition. It is noted that method 1000 can also include performing terrestrial transmissions between the devices. It is further notes that the definition of stage 1010 can be dynamically changed. For example, the grouping can alter in response to currently active devices.

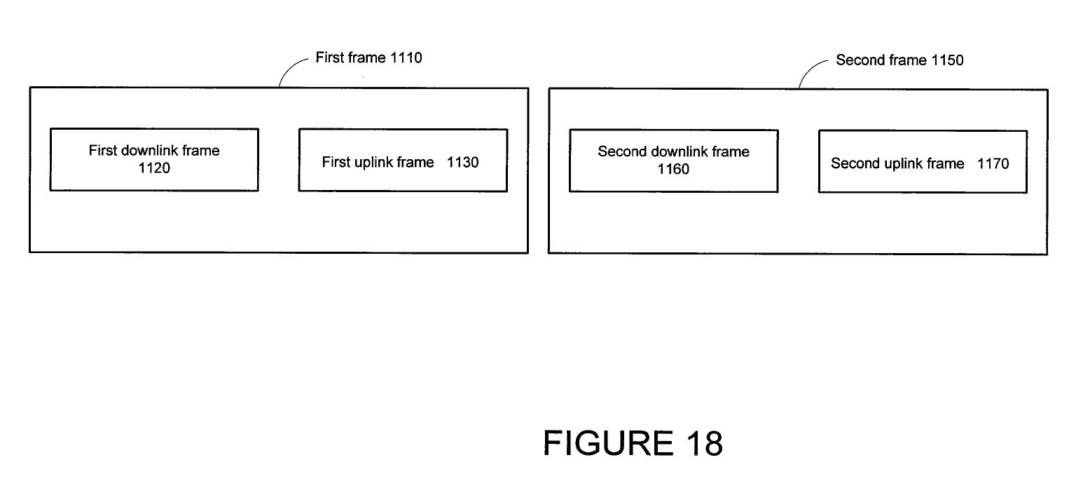

FIG. 18 illustrates a pair of frames 1110 and 1150 where the area covered by the satellite beam includes two groups of devices. The first frame 1110 includes a first downlink frame 1120 and a first uplink frame 1130. The second frame 1150 includes a second downlink frame 1160 and a second uplink frame 1170.

First downlink frame 1120 is allocated for downstream transmissions towards a first set of devices. It starts by transmitting upstream MAP message and downstream MAP message. Second uplink frame 1170 is allocated for uplink transmissions from at least one device out of the first set of devices. Second downlink frame 1160 is allocated for downstream transmissions towards a second set of devices. It starts by transmitting upstream MAP message and downstream MAP message. First uplink frame 1130 is allocated for uplink transmissions from at least one device out of the second set of devices.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A system, comprising:
a satellite antenna adapted to receive right hand circularly polarized radiation and left hand circularly polarized radiation over a satellite link, and
a terrestrial multiple sector antenna adapted to receive terrestrial communication; wherein the satellite antenna is oriented in relation to an imaginary vertical axis that is substantially parallel to multiple elements of the terrestrial multiple sector antenna.

2. The system according to claim 1 wherein the satellite antenna and the terrestrial multiple sector antenna are substantially fixed to a structural element.

3. The system according to claim 1 wherein the satellite antenna and the terrestrial multiple sector antenna are coupled to a structural element and are located within a radome; wherein the structural element is pivotally coupled to a base element.

4. The system according to claim 3 wherein location information is printed on an external surface of the radome.

5. The system according to claim 1 further comprising a interfacing unit adapted to selectively output radiation received by at least one receiving element out of the satellite antenna and an antenna element of the terrestrial multiple sector antenna.

6. The system according to claim 1 wherein the system comprises a first reception path for receiving information conveyed over the right hand circularly polarized radiation and a second reception path for receiving different information conveyed over the left hand circularly polarized radiation.

7. The system according to claim 1 wherein the terrestrial multiple sector antenna is adapted to receive WiMax compliant transmissions.

8. A method, comprising:
installing a base element; and
rotating an antenna unit that comprises a radome, a satellite antenna adapted to receive right hand circularly polarized radiation and left hand circularly polarized radiation over a satellite link, and a terrestrial multiple sector antenna adapted to receive terrestrial communication; wherein the radome comprises location information such as to direct a radome portion on which location information that corresponds to a location of the system is directed towards a certain direction.

9. The method according to claim 8 further comprising determining the certain direction by using a low cost direction finding unit.

10. The method according to claim 9 wherein the low cost direction finding unit is a compass.

11. The method according to claim 8 further comprising fixing the structural element to the base element.

12. The method according to claim 8 further comprising selectively receiving information over the satellite link or over the terrestrial link.

13. A method comprising:
determining an operational mode of a system that comprises a satellite antenna adapted to receive right hand circularly polarized radiation and left hand circularly polarized radiation over a satellite link, and a terrestrial multiple sector antenna adapted to receive terrestrial communication; and
selecting, in response to the operational mode, which radiation to output out of the radiation received by at least one receiving element out of the satellite antenna and an antenna element of the terrestrial multiple sector antenna.

14. The method according to claim 13 wherein a first operational mode comprises receiving information conveyed over the right hand circularly polarized radiation and receiving different information conveyed over the left hand circularly polarized radiation.

15. The method according to claim 13 wherein a second operational mode comprises receiving radiation from multiple elements of the terrestrial multiple sector antenna.

16. A method, the method comprising:
defining a modulation scheme in response to an expected communication load and in response to an expected signal to noise ratio within a beam area defined by a satellite beam; and
transmitting multiple modulated information streams over multiple satellite beams wherein the information streams are modulated in response to the modulation scheme; wherein the multiple satellite beams have substantially the same cross section and adjacent satellite beams convey information over different sets of carrier frequencies.

17. The method according to claim 16 wherein the modulation scheme comprises defining more robust modulations to areas located more remotely from a coastline.

18. The method according to claim 16 further comprises transmitting information streams over terrestrial links using carrier frequency sets that partially overlap at least one carrier frequency set of a satellite beam.

19. The method according to claim 16 further comprising transmitting at least one modulated information stream using a first polarization and using an orthogonal polarization for transmitted another modulated information stream.

20. The method according to claim 19 wherein the first polarization is a right hand circularly polarization.
